(19) United States
(12) Patent Application Publication
(10) Pub. No.: US 2017/0010057 A1
(43) Pub. Date: Jan. 12, 2017

(54) Heat Exchanger Floating Head Manipulation Device

(71) Applicant: David E. Griffis, JR., Lumberton, TX (US)

(72) Inventor: David E. Griffis, JR., Lumberton, TX (US)

(21) Appl. No.: 14/545,951

(22) Filed: Jul. 10, 2015

(51) Int. Cl. F28F 9/02; F16M 13/02; F28D 7/10

(52) U.S. Cl. CPC F28F 9/0241; F28D 7/103; F16M 13/02; F28F 2280/02

(57) ABSTRACT

A device for the manipulation of a floating head between secured and removed positions relative to a heat exchanger housing, and for suspension of the floating head between said positions as heat exchanging tubes are replaced or cleaned. The floating head has holding means such as a ring welded to the exterior for affixation of a lifting member, such as a chain, of a lifting means, such as a crane. The device comprises an elongated body having first and second opposed ends. The body has at least one opening for selective receipt of means for attaching the body to the holding means, whereby when the device is affixed to the floating head, the floating head may be manipulated and suspended at a pre-selected degree, such as approximately a 90 degree angle relative to the heat exchanger. A spinal projection extends from one end of the device body and is offset relative to the body at a pre-selected degree, such as approximately a 45 degree angle. A securing member is provided on the projection for selective receipt of the lifting member.

### BACKGROUND OF THE INVENTION

Brief Description of the Prior Art

This invention relates to industrial heat transfer equipment which includes a floating head at one of the exchanger. The floating head may be manipulated between closed, or locked, position, to completely open position, for the removal of tube bundles from the shell body of the equipment. There are many types of heat transfer equipment available, however one of the most widely known types comprises a plurality of parallel tubes encased in a relatively close fitting tubular shell. Provisions are made whereby a fluid flows outside the tubes, called the shell-side fluid, and a fluid flows inside the tubes, called the tube-side fluid. Although this tubular type equipment is generally referred to as heat exchangers, depending upon the specific service in which it is employed this equipment may be variously designated as heat exchangers, overhead condensers, surface condensers and vaporizers, etc. As used herein, including in the appended claims, the term “heat exchanger” means all shell and tube type equipment regardless of its specific designation for a particular purpose.

When heat exchangers are utilized under conditions wherein the temperature difference between the tube side and shell side fluids is large it is necessary that the heat exchanger design include means to allow for the difference in expansion of the tubes and of the shell. Various expedients may be employed to accommodate the expansion such as flexible sections built into the shell, U-shaped tubes, and others. Where an exchanger is used in a service which necessitates the removal of the tube bundle in order to clean the outside surfaces of the tubes a “floating head” is used which permits free expansion of the tube's heat yet permits the tube bundle to be removed readily for repairs and/or cleaning.

The removal of the tube bundle becomes necessary when a shell side fluid is used which is dirty or scale forming. The deposition of scale on the outside of the tubes interferes with effective heat transfer and must be removed in order to maintain maximum design efficiency. These scale deposits can be classified as hard, porous, or loose depending upon the nature of the materials forming the deposits. In some instances the scale may be removed by flushing operation or the use of various solvents which cleanse the equipment without the need for removing the tube bundle from the shell. More recalcitrant deposits such as hard deposits formed by water-deposited scale, corrosion products and so forth and even porous deposits formed by mud and dirt, coke and carbon, asphalt and tars which resist the flushing and/or solvent cleaning operations demand the removal of the tube bundle from the exchanger shell in order that the external surfaces of the tubes may be made conveniently accessible for mechanical cleaning equipment. After removing the cover plates of the stationary head or the stationary head if the cover is integral therewith and the tube plate is positioned between the shell and head the entire tube bundle is withdrawn from the exchanger shell by connecting a suitable prime remover to the tube sheet and applying a force sufficient to remove the tube bundle. In the removal of the tube bundle, care must be exercised to prevent injury to the tubes. When large bundles of tubes are badly fouled by scale deposits it is necessary to apply a considerable force to the stationary tube sheet. This resultant force may cause damages to the tube bundle. In addition large bundles of tubes which are not fouled may require a large force to overcome the inertia present and if the entire force necessary to remove the tube bundle is all applied at the tube sheet undesirable consequences may obtain. Thus, removal of the tubes requires a careful operation which includes manipulation of the floating head initially secured onto the shell body for complete removal from the shell body. This has required heavy duty lifting machinery, which may include a crane, which is secured at a point exterior of the floating head. Attention is directed to FIG. 1 (prior art). When installing or spotting or taking off a floating head on a shell and tube heat exchanger, the floating head will hang at about a 45 to 50 degree angle. This happens because the existing lifting lug is at an angle so that the shell cover can be installed without obstruction. The angle that the floating head hangs is important so that it can be installed without damaging the housing surface or a gasket or seal if used. The angle can also cause injury to the workers that are installing it by smashing or pinching their hands or fingers.

A typical prior art device is shown in Chinese patent publication no. CN201867115U. The disclosed device is unable to be used in combination with floating heads of varying sizes such that the resulting positioning of the head when removed from a heat exchanger housing will result in suspension of the device at a pre-selected angle relative to the stable heat exchanger housing.

The present invention provides a lifting device which is selectively installed on the existing lifting lug of the floating head by moving the center of gravity and thus permitting the device to act as a lever, forcing the head to hang, preferably, at a 90 degree angle, so that it can be installed safely and efficiently. The preferred device provides a series of openings to permit the device to be operable with a number of sizes of floating heads It adjust with seven holes that allow it to work with many different size floating heads. The preferred design of the device includes a straight end and another opposite one end that is at a pre-determined angle, such as a 45 degree angle to adjust for the depth of the floating head.

Field of the Invention

The invention is directed to a device for the installation, suspending and removal of a floating head of a heat exchanger body.

### SUMMARY OF THE INVENTION

The invention provides a device for the manipulation of a floating head between secured and removed positions relative to a heat exchanger housing, and for suspension of the floating head between said positions as heat exchanging tubes are replaced or cleaned. The floating head has holding means such as a ring welded to the exterior thereof for affixation of a lifting member of a lifting means, such as a crane, or the like. The device comprises an elongated body having first and second opposed ends. The body has at least one opening there through for selective receipt of means such as a bolt or lug, for attaching the elongated body to the holding means, whereby when the device is affixed to the floating head, the floating head may be manipulated and suspended at approximately a 90 degree angle relative to the heat exchanger. A spinal projection extends from one end of the device body and is offset relative to the body at a pre-determined angle, such as approximately a 45 degree angle. A securing member is provided on the projection for selective receipt of the lifting member. When secured together, the floating head and the device as described provide a unitary combination for use in removal of the floating head member of the heat exchanger.

### BRIEF DESCRIPTION OF THE DRAWINGS

FIG. 1 (prior art) is a perspective view of a prior art method of removing a floating head resulting in the head being placed at about a 22.5 degree angle relative to the heat exchanger body.

FIG. 2 (prior art) is a view similar to that of FIG. 1, further illustrating the positioning of the floating head relative to a heat exchanger body, using a conventional prior art method.

FIG. 3 is a schematic illustration of affixation of the present device upon the exterior of a floating head.

FIG. 4 is a view similar to FIG. 3, taken from the opposite side of the floating head and the device.

FIG. 5 is an illustration of the present device, viewed from one side.

FIG. 6 is an illustration of the present device viewed from the top looking downwardly.

FIG. 7 is an illustration of the device as it is mounted and affixed onto a floating head.

### DESCRIPTION OF THE PREFERRED EMBODIMENTS

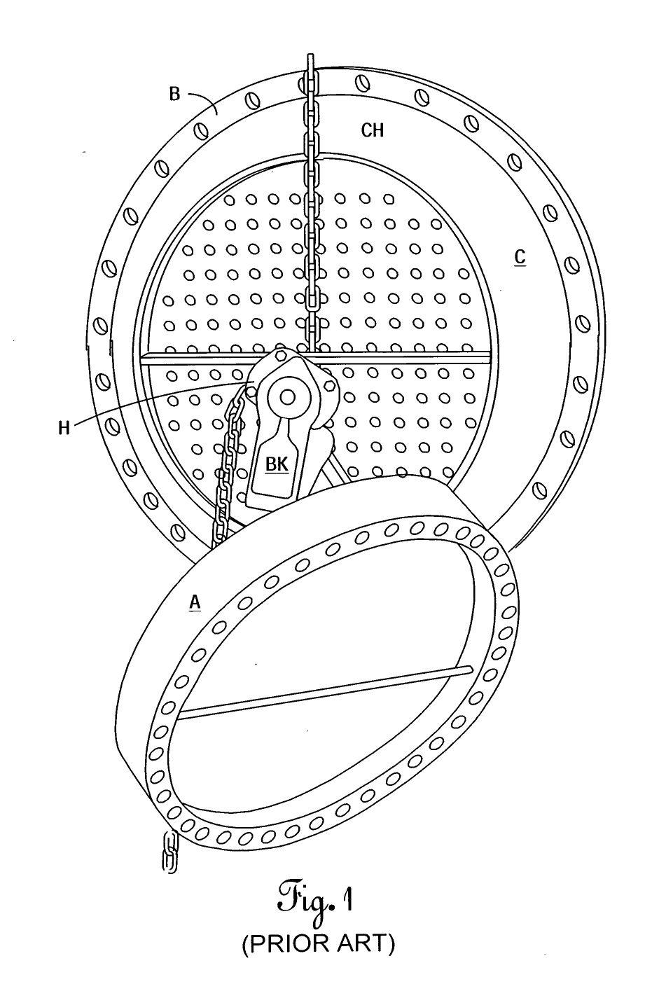

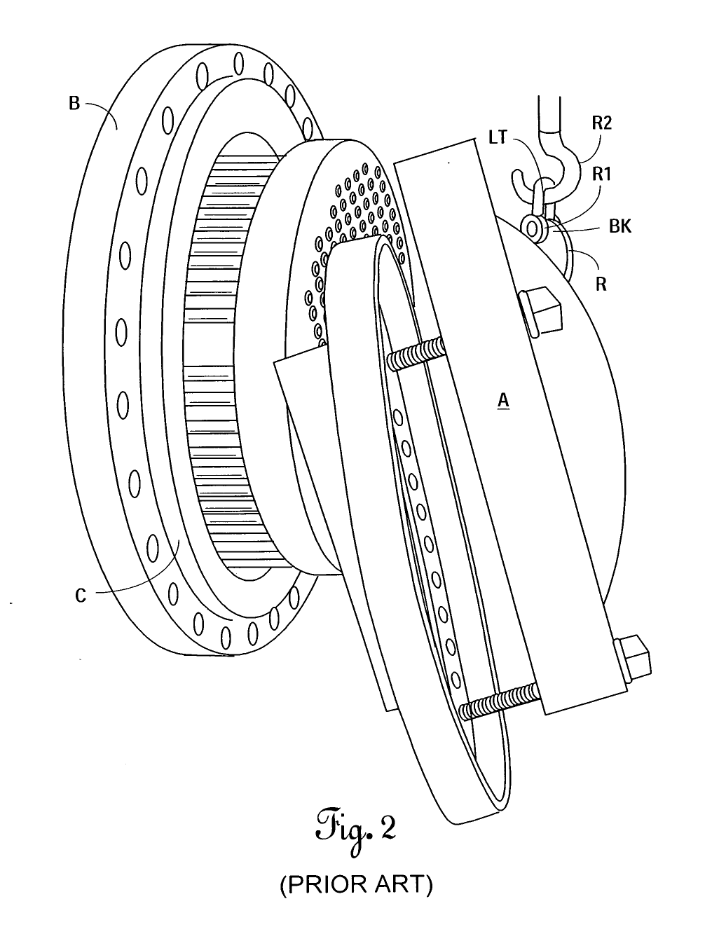

Now, with first reference to FIGS. 1 (prior art) and 2 (prior art), there is shown a conventional dome-shaped floating head A, suspended away from the body B of a heat exchanger housing C. The head A is shown in suspended position after removal from the housing C by use of a conventional hoist H and chain CH assembly. At one end of the chain CH is secured a block BK (FIG. 2) having a selectively opening latch LT. The floating head A, exteriorly convexed in shape, has welded or otherwise securely affixed thereon a grasping ring R having a receptacle R-1 for receipt of a clasping U-shaped member R-2, which prior to removal of the floating head A relative to the body B of the heat exchanger housing C, is snapped into place through latch LT and into the block BK. The receptacle or ring securing means R-1 is positioned on the exterior of the floating housing head A at approximately a 45 degree angle.

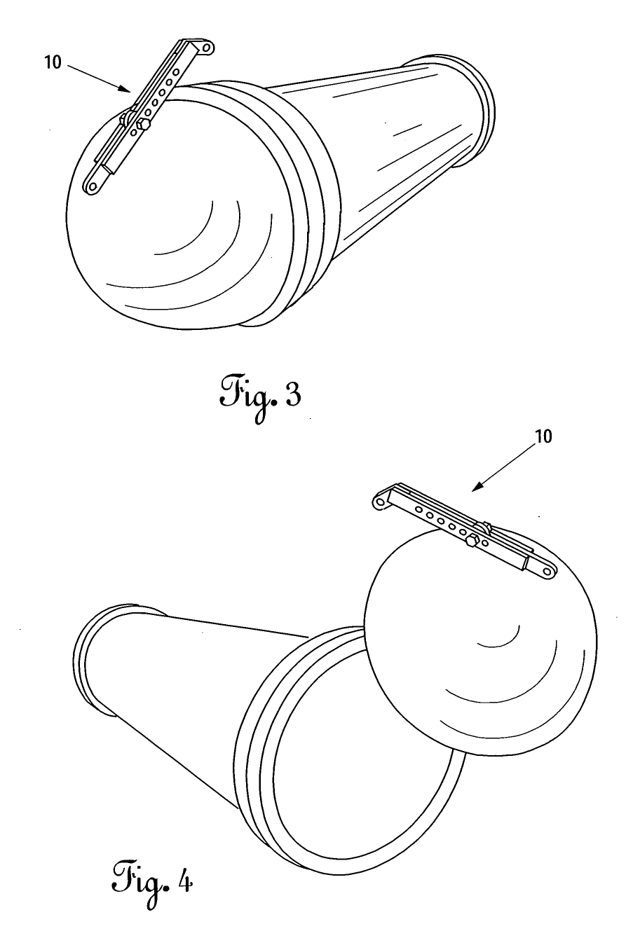

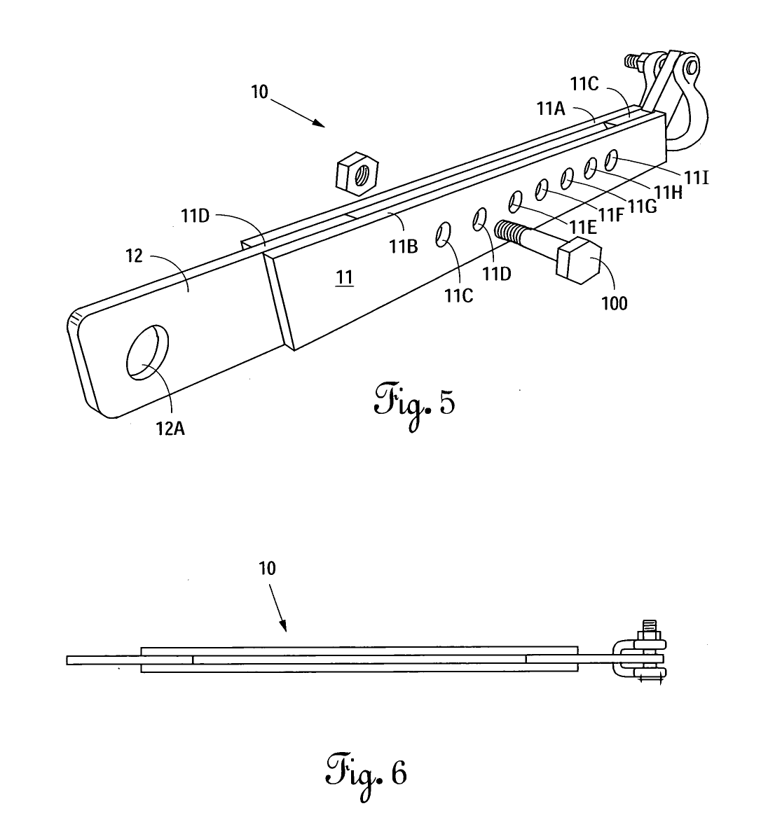

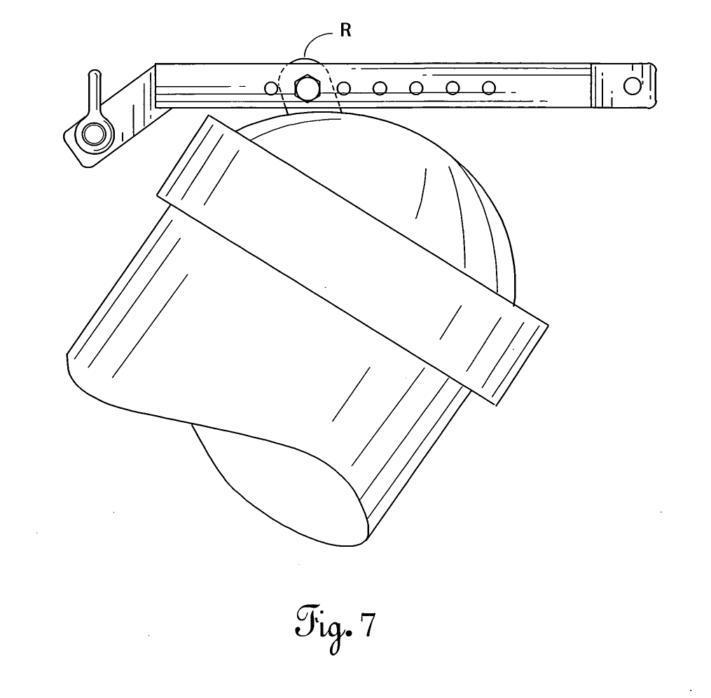

Now referring to FIGS. 3 through 7, there is shown the floating head manipulation device 10 as it is affixed to the floating head A of the heat exchanger housing C, for removal of the head A (FIG. 3) and replacement thereon (FIG. 4). As particularly shown in FIGS. 5 and 6, the device 10 consists of an elongated body member 11, preferably comprising parallel body members 11A and 11B, which are joined at each of the first and second opposite ends 11C and 11D of the body 11 by welding or the like. As shown in FIG. 5, a spinal projection 12 extends outwardly and away from the end 11D and has one end or portion thereof securely sandwiched between the body members 11A and 11B during the welding or other securing process. The spinal projection 12 has a spine opening 12A for receipt of a bolt or the like (not shown) for use in storage or positioning movements of the device 10 when it is not in use or is required to be manipulated into position for use.

As shown in FIGS. 3-6, the device 10 preferably has a body 11 which consists of parallel body members 11A and 11B through which are bored a series of spaced openings 11C-I, or the like, for receipt of a bolt 100 having a pin or similar member (not shown) to anchor the device 10 to the floating head A during operation for the removal or replacement of the floating head A onto the housing C of the of the heat exchanger. The purpose of providing a number of spaced openings 11C-I along the length of the body 11 is to accommodate various sizes of floating heads A used by the industry so that the device 10 may always be secured relative to the floating head A to permit holding or suspending of the floating head A at a pre-selected degree, such as 90 degrees, relative to the housing interior of the heat exchanger C when it is disengaged from the heat exchanger housing C.

### OPERATION

When it is desired to remove the floating head A to clean or repair the interior of the heat exchanger housing C, the device is moved into aligning position relative to the floating head A by transporting it to said location by means of a hoist or the like. The device 10 may be suspended for transport to the location by placing a bolt or the like through the spine opening 12A so that the device 10 is transported in a vertical position.

Referring to FIGS. 3, 4 and 7, the device 10 is mounted onto the floating head A by selecting one of the body openings 11C-I that comports to the particular size and configuration of the floating head A and so that the floating head A may be suspended during the cleaning or repairing operation at the desired degree relative to the heat exchanger housing C. The bolt 100 is then positioned through the selected opening 11C-I.

Concurrently, or just prior thereto, one end of chain CH of hoist H carrying block BK is moved to the head A. The block BK is secured into the receptacle R1 by snapping latch LT into the clasping member R2 of the receptacle R1. The floating head A may now be removed from the housing C from the position shown in FIG. 3 to the suspended position shown in FIG. 4, with the head A being held in such position during the cleaning or repairing or other operation. Thereafter, the operation is reversed and the head A is moved from the position shown in FIG. 4 to the initial position shown in the FIG. 3.

What is claimed and desired to be secured by Letters Patent:

1) A device for the manipulation of a floating head between secured and removed positions relative to a heat exchanger housing, said floating head having holding means on the exterior thereof for affixation of a lifting member of a lifting means, comprising:
(a) An elongated body having first and second opposed ends, said body having at least one opening there through for selective receipt of means for attaching said elongated body to said holding means on said floating head, whereby when the device is affixed to the floating head, said floating head may be manipulated and suspended at a pre-selected degree angle relative to said heat exchanger;
(b) a spinal projection extending from one end of said device body and offset relative to said body at approximately a 45 degree angle and including a spinal opening there through; and
(c) a securing member received within said spinal opening on said projection for selective receipt of said lifting member.

2) The device of claim 1 wherein said body comprises first and second parallel and spaced apart body members secured to one another at each end of said body, each body member having a series of openings there through and in alignment with one another.

3) The device of claim 1 wherein the floating head comprises an exteriorly convex-shaped dome member, said holding means being positioned on the exterior means at approximately a 45 degree angle.

4) The device of claim 1 wherein the pre-selected degree angle is approximately 90 degree

5) A device for the manipulation of a floating head between secured and removed positions relative to a heat exchanger housing, said floating head having holding means on the exterior thereof for affixation of a lifting member of a lifting means, comprising:
(a) An elongated body having first and second opposed ends, said body having at least one opening there through for selective receipt of means for attaching said elongated body to said holding means, whereby when the device is affixed to the floating head, said floating head may be manipulated and suspended at a pre-selected degree angle relative to said heat exchanger; and
(b) a spinal projection extending from one end of said device body and offset relative to said body at approximately a 45 degree angle and including a spinal opening there through for receipt of a securing member received within said spinal opening on said projection and for selective receipt of said lifting member.

6) The device of claim 5 wherein the pre-selected degree angle is approximately 90 degrees.

7) In combination with a floating head between secured and removed positions relative to a heat exchanger housing, said floating head having holding means on the exterior thereof for affixation of a lifting member of a lifting means, the improvement comprising:
(a) an elongated body having first and second opposed ends, said body having at least one opening there through for selective receipt of means for attaching said elongated body to said holding means on said floating head, whereby when the device is affixed to the floating head, said floating head may be manipulated and suspended at a pre-selected degree angle relative to said heat exchanger;
(b) a spinal projection extending from one end of said device body and offset relative to said body at a pre-determined angle and including a spinal opening there through; and
(c) a securing member received within said spinal opening on said projection for selective receipt of said lifting member.
